(19) United States
(12) Patent Application Publication
(10) Pub. No.: US 2009/0102430 A1
(43) Pub. Date: Apr. 23, 2009

(54) D.C./D.C. Converter-Regulator

(75) Inventors: Philippe Marguery, Poisat (FR); David Chesneau, Grenoble (FR)

Correspondence Address: GRAYBEAL JACKSON LLP, 155 - 108TH AVENUE NE, SUITE 350, BELLEVUE, WA, 98004-5973, US

(73) Assignee: STMicroelectronics SA, Montrouge (FR)

(21) Appl. No.: 11/989,121

(22) PCT Filed: Jul. 18, 2006
(86) PCT No.: PCT/FR2006/050726

§ 371 Date: Mar. 17, 2008

(30) Foreign Application Priority Data
Jul. 18, 2005 (FR) 0552226

(51) Int. Cl. H02J 7/04; H01M 8/02

(52) U.S. Cl. 320/162; 429/12

(57) ABSTRACT

A converter-regulator of a D.C. voltage into a D.C. voltage intended to connect a fuel cell to a filter capable of being connected to means of electrochemical storage of electric power in a charge operation of the storage means. The converter-regulator includes means capable of maintaining, during the charge operation, the voltage across the fuel cell at a given working voltage.

### PRIORITY CLAIM

This is a continuation-in-part application which claims priority from International Application No. PCT/FR2006/050726, published in French, filed Jul. 18, 2006, based on French patent Application No. 05/52226, filed Jul. 18, 2005, which is incorporated herein by reference.

### TECHNICAL FIELD

Embodiments of the present invention relate to a converter-regulator of a D.C. voltage into a D.C. voltage, or D.C./D.C. converter regulator, used for the charge of a battery, for example, of a cellular phone battery, via a fuel cell.

### BACKGROUND

In the following description, “battery” will be used to designate an assembly of accumulators coupled to act simultaneously, an accumulator being an electrolytic element which is charged by a D.C. current and which can then discharge, that is, give back, in the form of a D.C. current of reverse direction, part of the power built up in chemical form. There exist different types of batteries, including nickel-cadmium batteries, nickel-metal-hydride batteries, lead batteries, and lithium batteries. The electronic components of a cellular phone are generally supplied by a battery capable of being charged several times.

The charge of the battery of a portable phone may be performed at constant current with a minimum charge voltage or at constant voltage with a limited current according to the battery type. In a charge operation, the battery is generally connected to a generator providing an adapted charge voltage and charge current. The generator may include a converter of an A.C. voltage into a D.C. voltage receiving the A.C. voltage. It may also include a cell-supplied converter of a D.C. voltage into a D.C. voltage.

A fuel cell is a system for providing electric power in which the electricity is obtained by oxidation on an electrode of the cell of a reductant fuel coupled with the reduction on the other electrode of an oxidant, such as oxygen. The fuel may be hydrogen or methanol which is turned into hydrogen for the oxidation reaction. A fuel cell has the advantage of not being polluting since it only rejects water. The fuel of the fuel cell may be stored in a tank feeding the fuel cell. The performances and dimensions of currently-available fuel cells enable considering their use for the charge of a battery, especially of a cellular phone battery.

FIG. 1 shows an example of a curve 5 of variation of the voltage VFC across a fuel cell according to the current IFC provided by the fuel cell. Voltage VFC decreases from a maximum voltage VFCmax when no load is connected to the fuel cell down to a zero voltage for which the fuel cell provides a maximum current IFCmax. As an example, for a fuel cell likely to be used to supply a cellular phone battery, maximum voltage VFCmax may be on the order of 8 V and maximum current IFCmax may be on the order of from 400 to 500 mA. FIG. 1 also shows a curve 6 of variation of power PFC provided by the fuel cell. Curve 6 has a bell shape exhibiting a maximum for a given voltage VFC and current IFC.

To use a fuel cell for the charge of a battery, especially of a cellular phone battery, it is necessary to take into account the following constraints: the power provided by the fuel cell must be sufficiently high for the battery charge not to be excessively long, and the fuel cell efficiency must be high enough to avoid excessive consumption of the fuel of the fuel cell, which would translate as the impossibility to perform several successive charge operations without feeding again the fuel tank of the fuel cell.

Such constraints result in the inability to directly connect a fuel cell to a battery. Indeed, the battery would require provision of a high current by the fuel cell. An overconsumption of fuel by the fuel cell may then result, thus requiring frequent change of the fuel cell tank.

### SUMMARY

An embodiment of the present invention is a D.C./D.C. converter-regulator enabling use of a fuel cell to charge a battery, for example, a cellular phone battery.

According to another embodiment of the present invention, the regulator-converter has a high efficiency throughout an entire charge operation.

According to another embodiment of the present invention, the converter-regulator has a simple structure.

Another embodiment of the present invention is a method for converting the voltage provided by a fuel cell for the charge of a battery.

For this purpose, one embodiment of the present invention provides a converter-regulator of a D.C. voltage into a D.C. voltage intended to connect a fuel cell to a filter capable of being connected to means of electrochemical storage of electric power in a charge operation of the storage means. The converter-regulator includes means capable of maintaining, during the charge operation, the voltage across the fuel cell at a given working voltage.

According to an embodiment of the present invention, the converter-regulator includes means for providing an error signal representative of the difference between the voltage across the fuel cell and the given working voltage; and a voltage step-down or step-up circuit which drives the filter with an average voltage corresponding to the voltage across the fuel cell multiplied by a factor which depends on the error signal, whereby, when the voltage across the fuel cell is greater than the given working voltage, the current provided to the battery is increased and that, when the voltage across the fuel cell is lower than the given working voltage, the current provided to the battery is decreased.

According to an embodiment of the present invention, the converter-regulator includes means for setting the given working voltage.

According to an embodiment of the present invention, the converter-regulator includes a capacitor connected across the fuel cell.

According to an embodiment of the present invention, the voltage step-down or step-up circuit is a chopper circuit controlled by a cyclic rectangular signal having a duty cycle which depends on the error signal.

Another embodiment of the present invention provides a power supply system, intended to be connected to means of electrochemical storage of electric power in a charge operation of the storage means. The power supply system includes a fuel cell; a filter intended to be connected to the storage means during the charge operation; and a converter-regulator such as defined previously connecting the fuel cell to the filter.

According to an embodiment of the present invention, the filter includes an inductance intended to be series-connected to the storage means.

A further embodiment of the present invention provides an electronic system, especially a cellular phone, comprising means of electrochemical storage of electric power and a system for supplying said storage means such as previously defined.

A still further embodiment of the present invention provides a method for converting the voltage across a fuel cell into a supply voltage of a filter connected to means of electrochemical storage of electric power, in a charge operation of the storage means, comprising the maintaining, during the charge operation, of the voltage across the fuel cell at a given working voltage.

According to an embodiment of the present invention, the method includes the steps of providing an error signal representative of the difference between the voltage across the fuel cell and the given working voltage; and providing the filter with an average voltage corresponding to the voltage across the fuel cell multiplied by a factor which depends on the error signal, whereby, when the voltage across the fuel cell is greater than the given working voltage, the current provided to the battery is increased and, when the voltage across the fuel cell is smaller than the given working voltage, the current provided to the battery is decreased.

### BRIEF DESCRIPTION OF THE DRAWINGS

The foregoing features and advantages of the present invention, as well as others, will be discussed in detail in the following non-limiting description of specific embodiments thereof in connection with the accompanying drawings.

FIG. 1, previously described, shows the variation of the voltage across a fuel cell and of the power provided by the fuel cell versus the current provided by the fuel cell;

FIG. 2 schematically shows a cellular phone connected to a fuel cell via a converter-regulator according to an embodiment of the present invention;

FIG. 3 schematically shows an example of a converter-regulator according to an embodiment of the present invention;

FIG. 4 shows a more detailed embodiment of the converter-regulator of FIG. 3;

FIG. 5 shows the variation of characteristic voltages of the converter-regulator of FIG. 4 in operation;

FIG. 6 shows for the converter-regulator of FIG. 4 the variation of the voltage across the fuel cell, of the voltage across the battery, and of the current provided to the battery during a battery charge operation; and

FIG. 7 shows the efficiency variation of a converter-regulator according to an embodiment of the present invention according to the current provided by the fuel cell.

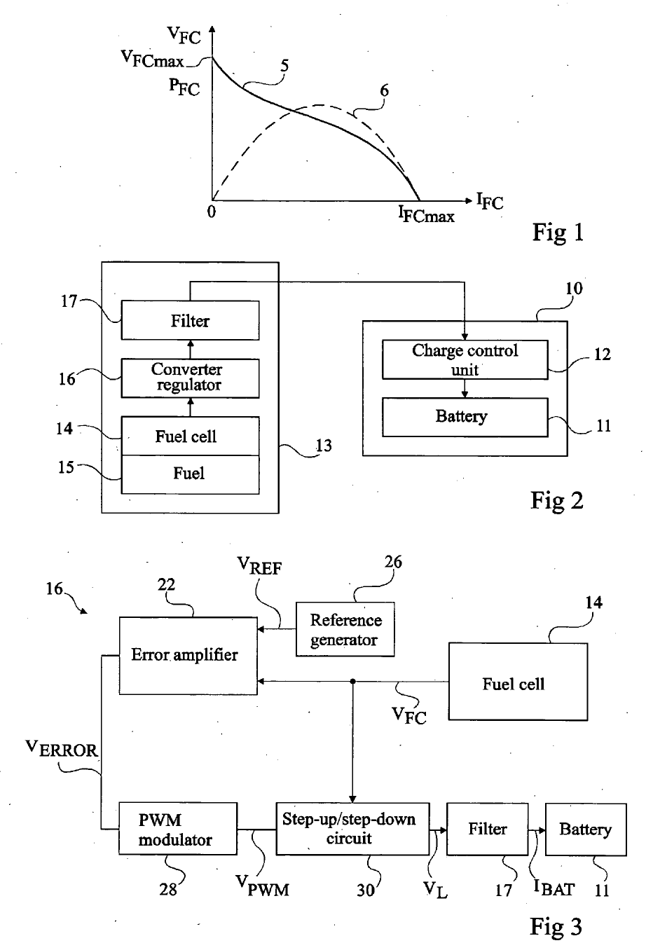

### DETAILED DESCRIPTION

The following discussion is presented to enable a person skilled in the art to make and use the invention. Various modifications to the embodiments will be readily apparent to those skilled in the art, and the generic principles herein may be applied to other embodiments and applications without departing from the spirit and scope of the present invention. Thus, the present invention is not intended to be limited to the embodiments shown, but is to be accorded the widest scope consistent with the principles and features disclosed herein. For clarity, same elements have generally been designated with same reference numerals in the different drawings.

FIG. 2 schematically shows a cellular phone 10 including a battery 11 connected to a charge control unit 12. Battery 11 is, for example, a battery of lithium-ion type. The charge of battery 11 is performed via an electric power source 13 including a fuel cell 14 using, for the provision of electric power, fuel stored in a tank 15. The cell may, for example, be a hydrogen or methanol fuel cell. Fuel cell 14 is connected to cellular phone 10 via a converter-regulator 16 and a filter 17. Charge control unit 12 is capable of detecting a connection between telephone 10 and power source 13 to trigger a charge operation of battery 11, for example, by detecting that a current greater than a determined current is supplied to battery 11. Charge control unit 12 is also adapted to detecting whether battery 11 is sufficiently charged to interrupt the charge operation.

During a charge operation, the operation of the fuel cell 14 is at a determined operating point, that is, at a determined couple of values (VFCopt, IFCopt) of voltage VFC and of current IFC. Such an operating point is called the optimum operating point and enables fast charge of the battery while avoiding too high a fuel consumption by the fuel cell. More specifically, embodiments of the present invention include maintaining of voltage VFC across fuel cell 14 at the voltage of optimum operating point VFCopt of fuel cell 14 in a charge operation. Thereby, fuel cell 14 provides a substantially constant operating current IFCopt to enable performing a charge at constant current.

FIG. 3 schematically shows an example of the converter-regulator 16 according to an embodiment of the present invention. Converter-regulator 16 includes an error amplifier 22 which compares voltage VFC across fuel cell 14 with a reference voltage VREF provided by a reference voltage generator 26. Error amplifier 22 provides an error voltage VERROR, representative of the difference between voltages VFC and VREF, to a PWM pulse-width modulator 28. Modulator 28 provides a pulse-width modulated square voltage VPWM to a regulation unit 30, which may correspond to a voltage step-down circuit or to a voltage step-up circuit. Unit 30 provides a voltage VL to filter 17 which drives battery 11 with a charge current IBAT. Charge control unit 12 is not shown in FIG. 3.

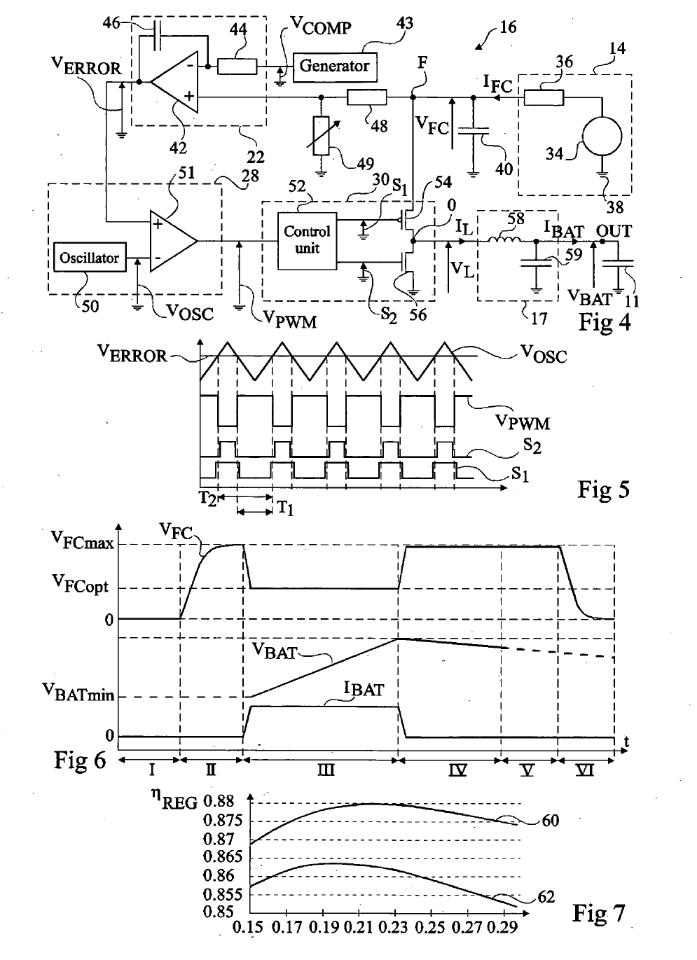

FIG. 4 shows a more detailed example of embodiment of converter-regulator 16 of FIG. 3. Fuel cell 14 is shown as a constant voltage generator 34, series-assembled with a resistor 36, representing the internal resistance of fuel cell 14. Fuel cell 14 is connected between a source of a reference voltage 38, generally the ground, and a node F. To avoid any excessive load of fuel cell 14, converter-regulator 16 includes a capacitor 40 connected between node F and the ground.

Error amplifier 22 includes an operational amplifier 42 having its inverting input (−) connected to the output of a generator 43 of a constant voltage VCOMP via a resistor 44. Further, the inverting input (−) is connected to the output of amplifier 42 via a capacitor 46. The non-inverting input (+) of amplifier 42 is connected to node F via a resistor 48. A variable resistor 49 is provided between the non-inverting input (+) and the ground.

Pulse-width modulator 28 includes an oscillator 50 providing a triangular voltage VOSC of constant frequency and an operational amplifier 51 having its non-inverting input (+) receiving error voltage VERROR and having its inverting input (−) receiving triangular voltage VOSC. Amplifier 51 is assembled as a comparator and provides a rectangular voltage VPWM. In the present example embodiment, voltage VFCopt of the optimum operating point of fuel cell 14 is on the order of 5 V, which corresponds to the provision of a current IFCopt on the order of from 200 to 300 mA, and battery 11 is a lithium-ion battery having a capacity on the order of from 600 to 800 mA·h (that is, from 2,160 coulombs to 2,880 coulombs). Regulation unit 30 then corresponds to a voltage step-down circuit which includes a control unit 52 receiving voltage VPWM and which provides two control voltages S1 and S2. Regulation unit 30 includes a P-type MOS transistor 54, having its source connected to node F and its drain connected to an intermediary node O, and an N-type MOS transistor 56 having its drain connected to node O and having its source connected to ground. The gate of transistor 54 is controlled by voltage S1 and the gate of transistor 56 is controlled by voltage S2. Filter 17 includes an inductance 58 connected between node O and an output terminal OUT of power source 13 and a capacitor 59 connected between output terminal OUT and the ground. The battery is shown as a capacitor 11 connected between output terminal OUT and the ground, the grounds of cellular phone 10 and of power source 13 being put in common on connection of cellular phone 10 to power source 13.

The supply of the components of error amplifier 22 and of pulse-width modulator 28 is performed via a stabilized voltage source, not shown, receiving, for example, voltage VFC.

FIG. 5 shows the variation of characteristic voltages of converter-regulator 16 during operation. Error amplifier 22 performs an operation of amplification of the difference between voltage VFC and a reference voltage and a filtering operation. The reference voltage may be adjusted by modifying the value of variable resistor 49. In the present example embodiment, error amplifier 22 corresponds to an assembly of subtractor-integrator type. Voltage VERROR is equal to the sum of a constant voltage VERROR0, or bias voltage, and of a variable voltage verror. The expression of variable voltage verror in the Laplace plane is the following:

$${v}_{error} = {V}_{FC} \cdot \frac{{R}_{49}}{{R}_{49} + {R}_{48}} \cdot \frac{{A}_{42} ( 1 + {R}_{44} {C}_{46} p )}{1 + ( 1 + {A}_{42} ) {R}_{44} {C}_{46} p} - {V}_{COMP} \frac{{A}_{42}}{1 + ( 1 + {A}_{42} ) {R}_{44} {C}_{46} p} \qquad ( 1 )$$

where A42 is the open loop gain of operational amplifier 42, R44, R48, and R49 are the respective values of resistors 44, 48, and 49, and C46 is the capacitance of capacitor 46.

Gain A42 being very large as compared with unity, equation (1) may be simplified as:

$${v}_{error} = {V}_{FC} \cdot \frac{{R}_{49}}{{R}_{49} + {R}_{48}} \cdot \frac{1 + {R}_{44} {C}_{46} p}{{R}_{44} {C}_{46} p} - {V}_{COMP} \frac{1}{{R}_{44} {C}_{46} p} \qquad ( 2 )$$

At low frequencies, equation (2) becomes:

$${v}_{error} = \frac{1}{{R}_{44} {C}_{46} p} ( {V}_{FC} \cdot \frac{{R}_{49}}{{R}_{49} + {R}_{48}} - {V}_{COMP} ) \qquad ( 3 )$$

The control of converter-regulator 16 tending to cancel variable voltage verror, voltage VFCopt towards which voltage VFC tends is thus given by the following relation:

$${V}_{FCopt} = {V}_{COMP} ( 1 + \frac{{R}_{48}}{{R}_{49}} ) \qquad ( 4 )$$

Voltage VPWM is obtained from the comparison between voltages VERROR and VOSC, shown to be superposed in FIG. 5. Voltage VPWM is a cyclic rectangular voltage having a duty cycle α equal to the ratio between time T1 for which voltage VPWM is in a high state during a cycle and duration T2 of a cycle. Duty cycle α depends on the value of voltage VERROR. Control voltages S1 and S2 are rectangular voltages obtained from voltage VPWM. When voltage S1 is low, transistor 54 is on and when voltage S1 is high, transistor 54 is off. When voltage S2 is high, transistor 56 is on and when voltage S2 is low, transistor 56 is off. Control voltages S1 and S2 are defined so that the rising and falling edges of voltages S1 and S2 are not simultaneous to avoid for transistors 54 and 56 to be simultaneously partially conductive. In the present example embodiment, voltage S1 substantially corresponds to the inverse of voltage VPWM, voltage S1 being however, for each cycle, in the low state for a time slightly shorter than T1, and voltage S2 substantially corresponds to the inverse of voltage VPWM, voltage S2 being, however, for each cycle, low for a time slightly longer than T1.

When voltages S1 and S2 are low, transistor 54 is on and transistor 56 is off. Node O is then directly connected to node F and voltage VL is equal to voltage VFC decreased by the source-drain voltage of transistor 54. The intensity of the current flowing through inductance 58 then tends to increase. When voltages S1 and S2 are high, transistor 54 is off and transistor 56 is on. Node O is then grounded. Voltage VL is substantially equal to the drain-source voltage of transistor 56 and the intensity of the current flowing through inductance 58 tends to decrease. The average of voltage VL is thus substantially equal to αVFC and the average of the current flowing through inductance 58 depends on duty cycle α and corresponds to the supply of a current IFC by fuel cell 14 which also depends on duty cycle α. Current IFC required by inductance 58 imposes the voltage across fuel cell 14, that is, voltage VFC at node F.

In steady state, voltage VFC is equal to voltage VFCopt of the optimum operating point of fuel cell 14 so that error voltage VERROR is equal to bias voltage VERROR0. The voltage VERROR0 corresponds to a steady-state voltage VPWM having a determined duty cycle α0. As an example, voltage VERROR0 can be selected so that duty cycle α0 is equal to 0.5. In this case, bias voltage VERROR0 is equal to half the sum of the maximum and minimum voltages provided by oscillator 50.

If voltage VFC is greater than VFCopt, a voltage VERROR greater than VERROR0 is obtained. Voltage VPWM then has a duty cycle α greater than α0. An increase in the average time for which transistor 54 is on, and thus an increase in the average current flowing through inductance 58, that is, an increase in the current IFC provided by fuel cell 14, are thus obtained. This results in a decrease in voltage VFC. Conversely, if voltage VFC is smaller than VFCopt, error voltage VERROR is smaller than VERROR0. Voltage VPWM then has a duty cycle α smaller than α0. A decrease in the average time for which transistor 54 is on, and thus a decrease in the average current flowing through inductance 58, that is, a decrease in current IFC provided by fuel cell 14, are thus obtained. This results in an increase in voltage VFC.

FIG. 6 illustrates the steps of a complete charge operation of battery 11 by fuel cell 14.

At step I, cellular phone 10 is not connected to output terminal OUT of power source 13. Current IBAT provided to output terminal OUT is thus zero. Battery 11 is discharged and voltage VBAT is equal to a minimum voltage VBATmin. Further, fuel cell 14 is deactivated, fuel tank 15 being, for example, disconnected from fuel cell 14. Voltage VFC is thus zero.

At step II, fuel cell 14 is activated, battery 11 being still unconnected to output terminal OUT. This is obtained, for example, by supplying fuel cell 14 with fuel. Fuel cell 14 then reaches a steady operation state, which translates as an increase in voltage VFC up to a voltage VFCmax of no charge.

At step III, battery 11 is connected to terminal OUT. Converter-regulator 16 then operates to maintain voltage VFC across fuel cell 14 at VFCopt, causing the provision of a substantially constant current IBAT to battery 11 and an increase in voltage VBAT.

At step IV, battery 11 is considered as being charged. Such a detection of the charge state of battery 11 may be performed by charge control unit 12. Battery 11 is then electrically disconnected from terminal OUT by charge control unit 12, cellular phone 10 remaining mechanically connected to electric power source 13. Converter-regulator 16 then no longer regulates voltage VFC, which rises back up to voltage VFCmax, while current IBAT becomes zero. Voltage VBAT decreases as battery 11 supplies the loads of cellular phone 10 to which it is connected.

At step V, cellular phone 10 is disconnected from terminal OUT. At step VI, fuel cell 14 is deactivated, for example, by cutting off the fuel supply of fuel cell 14.

FIG. 7 shows two curves 60, 62 of variation of the efficiency of converter-regulator 16 according to an embodiment of the present invention according to the current IFC provided by fuel cell 14. Curve 60 corresponds to a 3.6-V battery voltage VBAT which corresponds to an example of average voltage across battery 11 during a charge, and curve 62 corresponds to a 2.7-V battery voltage VBAT which corresponds to an example of the voltage across battery 11 at the beginning of a charge. The efficiency corresponds to the ratio between the power supplied to battery 11 and the power supplied by fuel cell 14 (that is, the sum of the power supplied to battery 11 and of losses). According to an embodiment of the present invention, the current provided to the battery being substantially constant and within a well-defined range, for example, from 150 mA to 290 mA, the efficiency of converter-regulator 16 is greater than 85% all along the charge.

In the previously-described example embodiment, a regulation unit 30 corresponding to a voltage step-down circuit has been considered. However, if the optimum working voltage VFCopt of fuel cell 14 is smaller than the average voltage driving filter 17, regulation unit 30 corresponds to a voltage step-up circuit, for example, controlled similarly to what has been previously described for the control of step-down circuit 30.

In the previously-described example, it has been considered that for a given VFC voltage, current IFC provided by fuel cell 14 is substantially constant. In practice, with a constant VFC, current IFC tends to slightly decrease along time.

According to another embodiment of the present invention, electric power source 13 may be directly provided at the level of cellular phone 10 and permanently mechanically connected to battery 11. A charge operation of battery 11 is then performed as described previously by the activation of fuel cell 14 of electric power source 13.

Of course, the present invention and embodiments thereof are likely to have various alterations, modifications, and improvements which will readily occur to those skilled in the art. In particular, for example, the filtering operation performed by error amplifier 22 in the above-described embodiments may be more complex than what has been previously described.

Embodiments of the present invention may be contained in a variety of different types of electronic devices and systems, such as cellular telephones, computer systems, portable devices such as personal digital assistants (PDAs) and MP3 players, and so on.

From the foregoing it will be appreciated that, although specific embodiments of the invention have been described herein for purposes of illustration, various modifications may be made without deviating from the spirit and scope of the invention.

1. A converter-regulator of a D.C. voltage into a D.C. voltage intended to connect a fuel cell to a filter capable of being connected to means of electrochemical storage of electric power in a charge operation of the storage means, the converter-regulator including means capable of maintaining, during the charge operation, the voltage across the fuel cell at a given working voltage.

2. The converter-regulator of claim 1, including:
means for providing an error signal representative of the difference between the voltage across the fuel cell and the given working voltages; and
a voltage step-down or step-up circuit which drives the filter with an average voltage corresponding to the voltage across the fuel cell multiplied by a factor which depends on the error signal, whereby, when the voltage across the fuel cell is greater than the given working voltage, the current provided to the battery is increased and that, when the voltage across the fuel cell is lower than the given working voltage, the current provided to the battery is decreased.

3. The converter-regulator of claim 1, including means for setting the given working voltage.

4. The converter-regulator of claim 1, comprising a capacitor connected across the fuel cell.

5. The converter-regulator of claim 2, wherein the voltage step-down or step-up circuit is a chopper circuit controlled by a cyclic rectangular signal having a duty cycle which depends on the error signal.

6. A power supply system, intended to be connected to means of electrochemical storage of electric power in a charge operation of the storage means, the power supply system including:
a fuel cell;
a filter intended to be connected to the storage means during the charge operation; and
the converter-regulator of claim 1, connecting the fuel cell to the filter.

7. The power supply system of claim 6, wherein the filter comprises an inductance intended to be series-connected to the storage means.

8. An electronic system, especially a cellular phone, including means of electrochemical storage of electric power and the system for supplying said storage means of claim 6.

9. A method for converting the voltage across a fuel cell into a supply voltage of a filter connected to means of electrochemical storage of electric power, in a charge operation of the storage means, including the maintaining, during the charge operation, of the voltage across the fuel cell at a given working voltage.

10. The method of claim 9, including the steps of:
providing an error signal representative of the difference between the voltage across the fuel cell and the given working voltage; and
providing the filter with an average voltage corresponding to the voltage across the fuel cell multiplied by a factor which depends on the error signal, whereby, when the voltage across the fuel cell is greater than the given working voltage, the current provided to the battery is increased and, when the voltage across the fuel cell is smaller than the given working voltage, the current provided to the battery is decreased.

11. A converter-regulator adapted to be coupled to an electric power storage device and adapted to be coupled to a fuel cell, the converter-regulator operable during a charging operation to control a voltage output from the fuel cell to maintain an efficiency of the converter-regulator above a minimum threshold value.

12. The converter-regulator of claim 11 wherein the minimum threshold value is approximately 85%.

13. The converter-regulator of claim 12 wherein the converter-regulator controls the voltage output from the fuel cell to provide a substantially constant current to the electric power storage device, the substantially constant current lying in the range of approximately 150-290 milliamps.

14. The converter-regulator of claim 11 further comprising:
an error detecting circuit having a first input adapted to receive the voltage output from the fuel cell and a second input adapted to receive a reference voltage, the error detecting circuit operable to generate an error signal indicating the difference between the voltage output from the fuel cell and the reference voltage;
a pulse width modulation circuit coupled to the error detecting circuit to receive the error signal, the modulation circuit operable to generate a pulse width modulated signal having a duty cycle that is a function of the error voltage; and
a regulation unit coupled to the pulse width modulation circuit receive the pulse width modulated signal, and having a first node adapted to receive the voltage output from the fuel cell and a second node adapted to be coupled to the electric power storage device, the regulation unit operable responsive to the pulse width modulated signal to maintain the voltage output from the fuel cell at a desired working voltage and to provide a substantially constant current to charge the electric power storage device.

15. The converter-regulator of claim 14 wherein the regulation unit comprises one of a step-down regulation unit and a step-up regulation unit.

16. The converter-regulator of claim 14 further comprising a filter having an input coupled to the second node and an output adapted to be coupled to the electric power storage device.

17. The converter-regulator of claim 11 wherein the electric power storage device comprises a battery.

18. The converter-regulator of claim 11 wherein the fuel cell comprises one of a hydrogen or methanol fuel cell.

19. A power supply system, comprising:
a fuel cell;
an electric power storage device; and
a converter-regulator coupled to the electric power storage device and coupled to the fuel cell, the converter-regulator operable during a charging operation to control a voltage output from the fuel cell to maintain an efficiency of the converter-regulator above a minimum threshold value.

20. The power supply system of claim 19 wherein the electric power storage device comprises a lithium-ion battery and wherein the fuel cell comprises one of a methanol and a hydrogen fuel cell.

21. An electronic device, comprising:
a fuel cell;
an electric power storage device;
a converter-regulator coupled to the electric power storage device and coupled to the fuel cell, the converter-regulator operable during a charging operation to control a voltage output from the fuel cell to maintain an efficiency of the converter-regulator above a minimum threshold value; and
electronic circuitry coupled to the electric power storage device to receive electrical power for operation of the circuitry.

22. The electronic device of claim 21 wherein the electronic circuitry comprise cellular telephone circuitry.

23. The electronic device of claim 22 wherein the cellular telephone includes a housing and wherein the fuel cell and converter-regulator are physically located within the housing.

24. A method of controlling a voltage output from a fuel cell for charging an electric storage device, the method comprising:
maintaining the voltage output from the fuel cell at a selected value;
deriving a substantially constant current from the voltage output from the fuel cell; and
supplying the substantially constant current to the electric storage device to charge the storage device.

25. The method of claim 24 further comprising:
determining a difference between the voltage output from the fuel cell and the selected value; and
providing the current to the electric storage device by selectively coupling the voltage output from the fuel cell to the electric storage device as a function of the determined difference.

26. The method of claim 24 wherein providing the current to the electric storage device comprises:
when the voltage output from the fuel cell is greater than the selected value, increasing the current provided to the electric storage device; and
when the voltage output from the fuel cell is less than the selected value, decreasing the current provided to the electric storage device.
